(19) United States
(12) Patent Application Publication
(10) Pub. No.: US 2026/0278617 A1
(43) Pub. Date: Sep. 17, 2026

(54) VISITOR RECEPTION SYSTEM AND VISITOR RECEPTION METHOD

(71) Applicant: GLORY LTD., Himeji-shi (JP)

(72) Inventors: Takahiro KAMIYA, Himeji-shi (JP); Daisuke NANBA, Himeji-shi (JP)

(73) Assignee: GLORY LTD., Himeji-shi (JP)

(21) Appl. No.: 19/549,027

(22) Filed: Feb. 25, 2026

(30) Foreign Application Priority Data
Mar. 14, 2025 (JP) 2025-041720

(51) Int. Cl. G06Q 30/015

(52) U.S. Cl. CPC G06Q 30/015

(57) ABSTRACT

A visitor reception system for a financial facility including a plurality of customer service areas includes: a visitor reception device disposed at the financial facility and configured to receive an operation from a customer; a computer configured to determine at least one of a purpose of a visit of the customer and attribute information of the customer in response to the operation; and a staff terminal operable by an employee of the financial facility.

### CROSS-REFERENCE TO RELATED APPLICATION

The present application claims the benefit of priority to Japanese Patent Application No. 2025-041720 filed on Mar. 14, 2025, the entire contents of which are hereby incorporated herein by reference.

### BACKGROUND OF THE INVENTION

### Field of the Invention

The present disclosure relates to a visitor reception system and a visitor reception method.

### Description of the Related Art

JP2012-185625A, for example, discloses a visitor reception system (“automatic reception system” in the document) including a visitor reception device. In response to an incoming customer operating the visitor reception device, the visitor reception system adds the customer's reception information to a queue and issues a numbered ticket. In response to an employee at a window selecting the reception information, the visitor reception system displays the number and calls the customer to the window.

The visitor reception system, however, merely calls a customer to a window and fails to involve information including information on the purpose of the customer's visit and the customer's attribute information. The customer needs to again provide another employee at the window with information including information on the purpose of the customer's visit and the customer's attribute information. The visitor reception system has room for improvement for flexible customer service.

The present disclosure has an object of providing a visitor reception system and a visitor reception method each of which allows flexible guiding and service.

### SUMMARY OF THE INVENTION

To attain the above object, a visitor reception system as a first aspect of the present disclosure is a visitor reception system for a financial facility including a plurality of customer service areas, the visitor reception system including:
a visitor reception device disposed at the financial facility and configured to receive an operation from a customer;
a computer configured to determine at least one of a purpose of a visit of the customer and attribute information of the customer in response to the operation; and
a staff terminal operable by an employee of the financial facility and configured to (i) obtain the at least one of the purpose of the visit and the attribute information that the computer has determined and (ii) designate from among the plurality of customer service areas a destination to which to guide the customer, the destination corresponding to the at least one of the purpose of the visit and the attribute information.

As an embodiment of the present disclosure, the visitor reception system may be further configured such that
the staff terminal includes:
a display configured to display at least one candidate for the destination among the plurality of customer service areas; and
an input interface configured or programmed to receive an operation for designating the destination from among the at least one candidate.

As an embodiment of the present disclosure, the visitor reception system may be further configured such that
the plurality of customer service areas includes a first-level customer service area and a second-level customer service area, and
the staff terminal is configured to designate the first-level customer service area or the second-level customer service area on a basis of the at least one of the purpose of the visit and the attribute information.

As an embodiment of the present disclosure, the visitor reception system may be further configured such that
the staff terminal operates to designate the second-level customer service area, which has a higher confidentiality level than the first-level customer service area, on a basis of the at least one of the purpose of the visit and the attribute information.

As an embodiment of the present disclosure, the visitor reception system may be further configured such that

As an embodiment of the present disclosure, the visitor reception system may be further configured such that
the visitor reception device includes a camera configured to capture an image of the customer's face,
the staff terminal includes a display configured to display a vacant room as a candidate from among the first-level customer service area and the second-level customer service area together with the image of the customer's face.

As an embodiment of the present disclosure, the visitor reception system may be further configured such that
the staff terminal is configured to designate the first-level customer service area or the second-level customer service area on a basis of a neural network identified through mechanical deep learning corresponding to an artificial intelligence.

As an embodiment of the present disclosure, the visitor reception system may be further configured such that
the staff terminal is configured to identify the at least one candidate on a basis of the at least one of the purpose of the visit and the attribute information.

As an embodiment of the present disclosure, the visitor reception system may be further configured such that
the operation includes having reservation information read by the visitor reception device, the reservation information having been issued by an appointment system of the financial facility, and
the computer is configured to determine the at least one of the purpose of the visit and the attribute information on a basis of the reservation information.

As an embodiment of the present disclosure, the visitor reception system may be further configured such that
the operation includes having medium information read by the visitor reception device, the medium information being stored in a portable device owned by the customer, and
the staff terminal includes a display configured to display determination information determined on a basis of the medium information.

As an embodiment of the present disclosure, the visitor reception system may be further configured such that
the visitor reception device includes a camera configured to capture an image of the customer, and
the staff terminal includes a display configured to display the image.

To attain the above object, a visitor reception method as a second aspect of the present disclosure is a visitor reception method for a financial facility including a plurality of customer service areas, a visitor reception device operable by a customer, and a staff terminal operable by an employee, the visitor reception method including:
determining at least one of a purpose of a visit of the customer and attribute information of the customer in response to the visitor reception device receiving an operation from the customer; and
designating from among the plurality of customer service areas a destination to which to guide the customer, the destination corresponding to the at least one of the purpose of the visit and the attribute information.

The present disclosure provides a visitor reception system and a visitor reception method each of which allows flexible guiding and service.

The above-mentioned and other embodiments, procedures, features, and effects of the present disclosure will be more apparent from the following detailed description of the embodiments with reference to the drawings.

### BRIEF DESCRIPTION OF THE DRAWINGS

FIG. 1 is a plan view of a financial facility with an example layout.

FIG. 2 is a block diagram illustrating a visitor reception system.

FIG. 3 is a flowchart of how to receive a visitor.

FIG. 4 is a table that shows a customer's actions, an employee's actions, and automated tasks at the time of visitor reception.

### DETAILED DESCRIPTION OF THE PREFERRED EMBODIMENTS

### Outline of Financial Facility

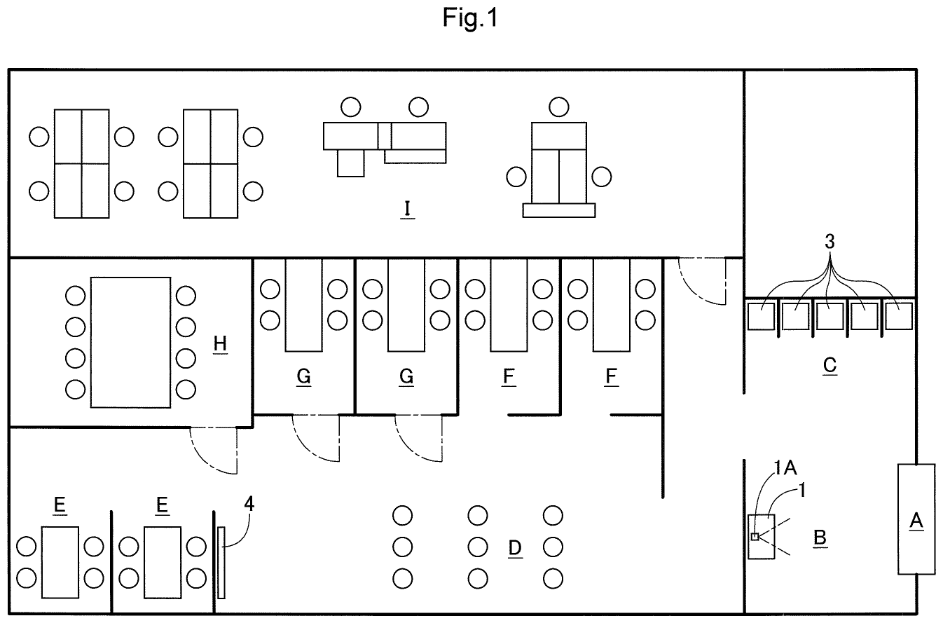

FIG. 1 illustrates a financial facility such as a bank branch with an entrance A, a self-service reception area B, a self-service transaction booth C, a waiting area D, two basic customer service areas E, two individual customer service areas F, two private customer service areas G, a consultation room H, and a back office I. The financial facility allows a visitor (which is an unlimited example of “customer”) to walk from the entrance A to the self-service reception area B or the self-service transaction booth C. The basic customer service area E corresponds to a “first-level customer service area”. At least one of the individual customer service area F, the private customer service area G and the consultation room H corresponds to a “second-level customer service area”. In another embodiment, the areas E and F may be a “first-level customer service area” and the areas G and H may be a “second-level customer service area”. Each of the rooms corresponding to the areas E and F may be an opened room without a door. Each of the rooms corresponding to the areas G and H may be a closed room with a door.

The financial facility has in the self-service reception area B a visitor reception device 1 operable by a visitor.

The visitor reception device 1 includes a touchscreen display 1B configured to receive from a visitor an input of, for example, the purpose and/or nature of the visit. The visitor reception device 1 also includes a camera 1A configured to capture an image of a visitor standing in front of the visitor reception device 1, that is, a visitor operating the visitor reception device 1.

The financial facility has in the self-service transaction booth C two or more automatic teller machines (ATM) 3 each usable by an individual customer to deposit cash into or withdraw cash from a deposit account. The ATMs 3 are connected to a core banking server over an intra-bank network (not illustrated in the drawings), so that a cash deposit or withdrawal at an ATM 3 automatically updates the account. The financial facility may have in the self-service transaction booth C an automatic money-changing machine or an automatic tax and public payment machine, for example, in addition to the ATMs 3.

The financial facility has in the waiting area D a calling device 4 and two or more chairs each for a visitor to sit on to wait to be called by an employee.

The basic customer service areas E are each, for example, a booth for a customer to have a casual consultation and small talk with an employee. The individual customer service areas F are each, for example, an area for a customer to carry out various procedures while consulting an employee, and are separated from each other with a partition. The individual customer service area F has a higher confidentiality level than the basic customer service area E. The private customer service areas G are each, for example, an area for a customer to consult an employee about a high-value loan, and are each provided with a door for isolation from the waiting area D. The private customer service area G has a higher confidentiality level than the basic customer service area E and the individual customer service area F. The consultation room H is an area for a large number of people to discuss business or for a valued customer, and is provided with a door for isolation from the waiting area D. The consultation room H has a higher confidentiality level than the basic customer service area E and the individual customer service area F. The basic customer service areas E, the individual customer service areas F, the private customer service areas G, and the consultation room H are each an unlimited example of “customer service area” and an unlimited example of “destination”. An employee may consider the attributes of the customer to decide which customer service area to guide the customer to.

The back office I is an area in which staff are present at all times and off-limits to visitors.

### Configuration of Visitor Reception System

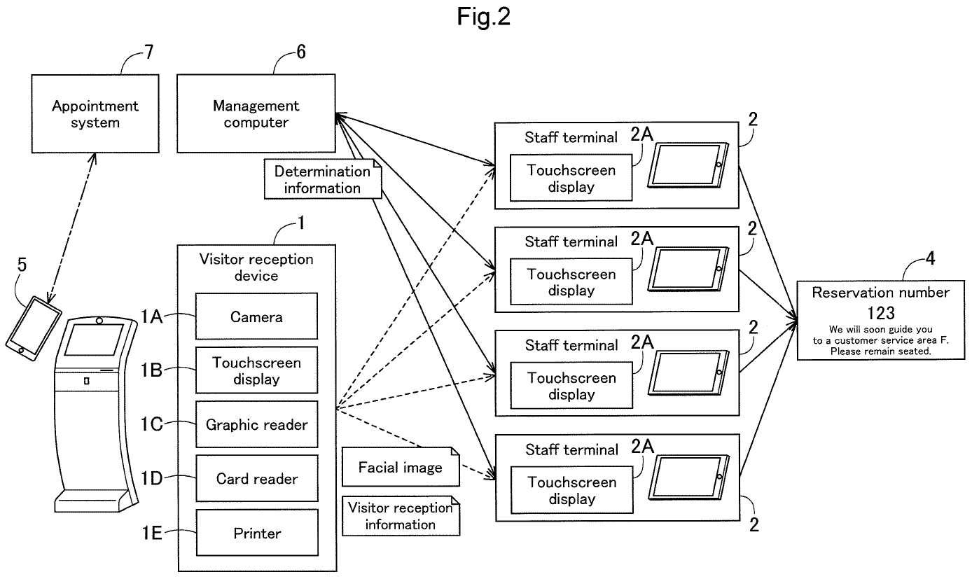

The description below deals with a visitor reception system of the present disclosure with reference to FIG. 2. The visitor reception system includes a visitor reception device 1, two or more staff terminals 2, and a calling device 4 each including a non-volatile memory (not illustrated in the drawings) configured to store computer programs and a processor (not illustrated in the drawings) configured to execute the programs, and are each capable of performing various control operations in accordance with control programs. The processor may be in the form of a central processing unit (CPU), a field-programmable gate array (FPGA), a graphics processing unit (GPU), an application-specific integrated circuit (ASIC), an application-specific standard product (ASSP), or a combination of two or more selected from the above circuits. The visitor reception device 1, the staff terminals 2, and the calling device 4 each perform various functions in response to the processor executing the programs, The programs may be in the form of, for example, executable programs generated by a compiler and a linker or program code sequentially executable by an interpreter. The visitor reception system may, as illustrated in FIG. 2, include a management computer 6 containing a storage configured to store information on attributes of each customer (for example, the frequency of transactions and their importance). The management computer 6 is an unlimited example of “computer” and “determiner”; specifically, it may be configured to determine the purpose of a customer's visit on the basis of what operation the customer has carried out on the visitor reception device 1.

As illustrated in FIG. 2, the visitor reception device 1, the staff terminals 2, the calling device 4, and the management computer 6 are connected to and capable of communicating with one another over, for example, an intra-bank network. The visitor reception device 1, the calling device 4, and the management computer 6 are configured or programmed to communicate with one another by means of, for example, at least one of a wired communication in conformity with a communications standard such as IEEE1394 (registered trademark) or Ethernet (registered trademark) and a wireless communication in conformity with a Bluetooth (registered trademark) or Wi-Fi standard. The staff terminals 2 are configured or programmed to communicate with one another by means of a wireless communication in conformity with a Bluetooth or Wi-Fi standard.

The visitor reception device 1 includes a camera 1A, a touchscreen display 1B, a graphic reader 1C, a card reader 1D, and a printer 1E. The camera 1A is configured to capture an image of a customer operating the visitor reception device 1, and may have the function of face authentication. The touchscreen display 1B is configured to display possible options of, for example, the purpose and/or nature of a customer's visit to receive an input about the purpose and/or nature.

The graphic reader 1C functions to scan an image and recognize from the scanned image a graphic code such as a QR code (registered trademark), a data matrix, a bar code, or a color code. The graphic reader 1C is, in other words, configured or programmed to read a graphic code. The graphic reader 1C, for instance, reads a graphic code on the screen of a smartphone 5. A customer uses their smartphone 5 to access an appointment system 7 of the financial institution and make an appointment to visit the facility. The graphic reader 1C is also capable of reading a graphic code on a sheet of paper. The graphic code is unlimited example of “reservation information”. The graphic reader 1C is an unlimited example of “computer” and “determiner”; specifically, it may be configured to determine the purpose of a customer's visit on the basis of what operation the customer has carried out on the visitor reception device 1.

The card reader 1D is configured to, for instance, read information on a customer from the customer's bank card or bankbook. The printer 1E is configured to issue to a customer a call number ticket with a call number printed thereon.

The staff terminals 2 are each in the form of a tablet computer including a touchscreen display 2A and carried by an employee. The staff terminals 2 are each capable of data communication with the visitor reception device 1, the calling device 4, and the management computer 6 over an intra-bank network. The touchscreen display 2A is configured to receive an employee's operations such as an operation for calling a customer to one of the basic customer service areas E, the individual customer service areas F, the private customer service areas G, and the consultation room H. The touchscreen display 2A displays various pieces of information related to, for example, the staff's work and/or the purpose of a customer's visit. The touchscreen display 2A is an unlimited example of “display” and an unlimited example of “input interface”.

The calling device 4 includes a display configured to display a call number and a loudspeaker for audio guidance. The display may be in the form of, for example, a liquid crystal display monitor, an organic LED monitor, or a 7-segment monitor.

In response to being operated by an employee, the calling device 4 causes its display to display a call number and its loudspeaker to send out a message that prompts the customer corresponding to the call number to move to one of the basic customer service areas E, the individual customer service areas F, the private customer service areas G, and the consultation room H.

### Flow of Receiving Visitor

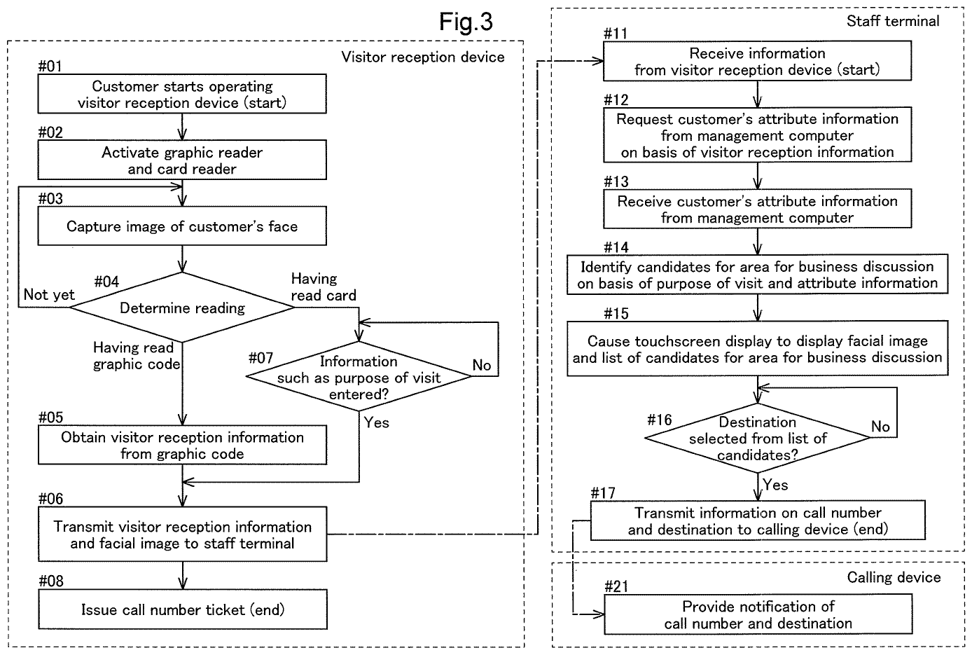

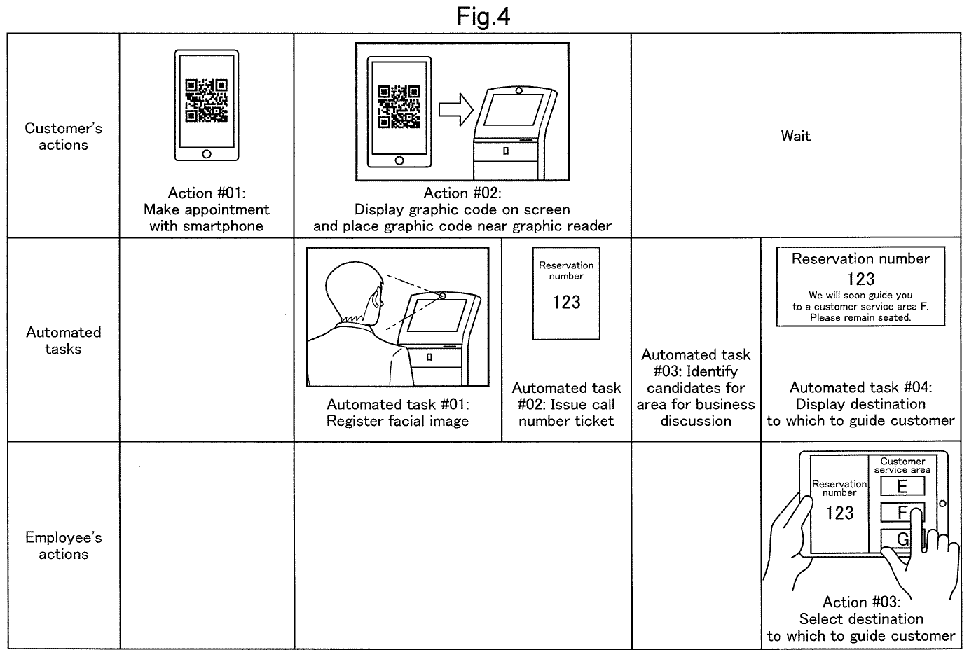

The description below deals with how to receive a visitor with use of the visitor reception system with reference to FIGS. 3 and 4. FIG. 3 shows steps #01 to #08 that the visitor reception device 1 performs. FIG. 4 illustrates an example including action #01, that is, a customer making an appointment to visit the facility with use of their smartphone 5. A customer may omit to make such an appointment.

A customer starts to operate the visitor reception device 1 (step #01 in FIG. 3), in response to which the processor of the visitor reception device 1 activates the graphic reader 1C and the card reader 1D (step #02 in FIG. 3) to allow the customer to (i) place a graphic code near the graphic reader 1C for the graphic reader 1C to read the graphic code or (ii) have their bank card read by the card reader 1D. The example illustrated in FIG. 4 includes action #02, that is, the customer causing the smartphone 5 to display a graphic code on its screen and placing the screen near the graphic reader 1C. At this stage, the processor of the visitor reception device 1 causes the camera 1A to capture an image of the customer's face (step #03 in FIG. 3 and automated task #01 in FIG. 4).

The processor of the visitor reception device 1 then determines whether the visitor reception device 1 has read a portable device that the customer has presented (step #04 in FIG. 3), that is, whether the graphic reader 1C has read a graphic code and whether the card reader 1D has read a bank card. If neither the graphic reader 1C nor the card reader 1D has read a graphic code or a bank card (“Not yet” in step #04 in FIG. 3), the process repeats steps #03 and #04. The customer carries out an operation that includes having reservation information read by the visitor reception device 1, the reservation information having been issued by the appointment system 7 of the financial facility or having medium information read by the visitor reception device 1, the medium information being stored in a portable device (for example, a bank card or a bankbook) owned by the customer.

The graphic code includes information on the purpose of the visit. If the graphic reader 1C has read a graphic code (“Having read graphic code” in step #04 in FIG. 3), the processor of the visitor reception device 1 obtains visitor reception information from the graphic code (step #05 in FIG. 3). The visitor reception information includes information on the purpose of the visit. The graphic reader 1C is configured or programmed to determine the purpose of the visit on the basis of the graphic code. The processor of the visitor reception device 1 transmits the visitor reception information and the facial image to each of the staff terminals 2 (step #06 in FIG. 3).

If the card reader 1D has read a bank card (“Having read card” in step #04 in FIG. 3), the processor of the visitor reception device 1 determines whether the customer has tapped on the touchscreen display 1B to enter information on, for example, the purpose of the visit (step #07 in FIG. 3). If the customer has not entered information on, for example, the purpose of the visit (“No” in step #07 in FIG. 3), the process repeats step #07 such that the processor of the visitor reception device 1 waits for the customer to enter the information. If the customer has entered information on, for example, the purpose of the visit (“Yes” in step #07 in FIG. 3), the visitor reception device 1 receives, as visitor reception information, information on the bank card as well as the information entered, that is, the information on the purpose of the customer's visit that the customer has entered on the touchscreen display 1B. The processor of the visitor reception device 1 transmits the visitor reception information and the facial image to each of the staff terminals 2 (step #06 in FIG. 3).

After the transmission, the printer 1E issues a call number ticket (step #08 in FIG. 3 and automated task #02 in FIG. 4). In step #06, the processor of the visitor reception device 1 transmits information on a call number as well.

FIG. 3 shows steps #11 to #17 that a staff terminal 2 performs. The communication module of the staff terminal 2 receives the above information from the visitor reception device 1 (step #11 in FIG. 3). The processor of the staff terminal 2 then requests the customer's attribute information from the management computer 6 on the basis of the visitor reception information (step #12 in FIG. 3).

In response to the request, the processor, for example, of the management computer 6 transmits the attribute information to the staff terminal 2. The communication module of the staff terminal 2 receives the attribute information from the management computer 6 (step #13 in FIG. 3). The attribute information of the customer includes information on their name, age, gender, family make-up, deposit, and recent transactions.

The processor of the staff terminal 2 extracts the information on the purpose of the visit from the visitor reception information and identifies candidates for a customer service area on the basis of the purpose of the visit and the attribute information from the management computer 6 (step #14 in FIG. 3 and automated task #03 in FIG. 4). The processor of the staff terminal 2 has the function of obtaining information on the vacancy of each of the basic customer service areas E, the individual customer service areas F, the private customer service areas G, and the consultation room H, so that the processor identifies vacant rooms as candidates. The processor of the staff terminal 2 then causes the touchscreen display 2A to display the facial image from the visitor reception device 1 and a list of candidates for a customer service area (step #15 in FIG. 3). That is, the staff terminal 2 includes the touchscreen display 2A configured to display a vacant room as a candidate from among the first-level customer service area and the second-level customer service area together with the image of the customer's face. The processor identifies the candidates on the basis of, for example, whether the purpose of the visit involves confidential information and/or whether the customer is a valued customer (for example, a VIP customer). The processor may identify the candidates with use of, for example, a lookup table indicative of the input-output correspondence or a neural network (or an artificial intelligence) identified through mechanical deep learning. That is, the staff terminal 2 is configured to designate the first-level customer service area or the second-level customer service area on a basis of a neural network identified through mechanical deep learning corresponding to an artificial intelligence. The processor of the staff terminal 2 may be configured to identify the candidates on the basis of the purpose of the visit alone or the attribute information alone. In a case of the customer being the valued customer for example, the staff terminal 2 operates to designate the second-level customer service area, which has a higher confidentiality level than the first-level customer service area, on a basis of the at least one of the purpose of the visit and the attribute information.

As described above, the staff terminals 2 are each configured to obtain information on the purpose of a customer's visit that the determiner (namely, at least one of the graphic reader 1C and the management computer 6) has determined, and are each configured or programmed to specify from among two or more customer service areas a destination to which to guide the customer which destination corresponds to at least one of the purpose of the visit and attribute information. The staff terminals 2 each include a touchscreen display 2A configured to display determination information determined on the basis of the above medium information and an image of the customer that a camera 1A has captured which camera 1A is configured to capture an image of a customer. The determination information is, for example, (i) at least a portion of the attribute information of the customer (for example, information on their name, age, gender, family make-up, deposit, or recent transactions) or (ii) reservation information that the customer has obtained from the appointment system 7 on the basis of the medium information in the event that, for instance, the customer has forgotten to bring a portable device that shows a graphic code. That is, the staff terminal 2 is configured to designate the first-level customer service area or the second-level customer service area on a basis of the at least one of the purpose of the visit and the attribute information.

An employee selects a destination to which to guide the customer from the list of candidates for a customer service area on the touchscreen display 2A (action #03 in FIG. 4). At this stage, the processor of the staff terminal 2 determines whether a destination has been selected from the list (step #16 in FIG. 3). If no destination has been selected (“No” in step #16 in FIG. 3), the process repeats step #16.

If a destination has been selected (“Yes” in step #16 in FIG. 3), the processor of the staff terminal 2 transmits to the calling device 4 information on the call number from the visitor reception device 1 and the destination selected (step #17 in FIG. 3).

In response to receiving the information from the staff terminal 2, the calling device 4 provides a notification of the call number and the destination (step #21 in FIG. 3 and automated task #04 in FIG. 4).

### Advantages of Embodiments

The present disclosure provides a visitor reception system for a financial facility including a plurality of customer service areas (that is, for example, the basic customer service areas E, the individual customer service areas F, the private customer service areas G, and the consultation room H), the visitor reception system including: a visitor reception device 1 disposed at the financial facility and configured to receive an operation from a customer; a computer (that is, at least one of the graphic reader 1C and the management computer 6) configured to determine at least one of a purpose of a visit of the customer and attribute information of the customer in response to the operation; and a staff terminal 2 operable by an employee of the financial facility and configured to (i) obtain the at least one of the purpose of the visit and the attribute information that the computer has determined and (ii) designate from among the plurality of customer service areas a destination to which to guide the customer, the destination corresponding to the at least one of the purpose of the visit and the attribute information.

The above configuration allows the staff terminal 2 to receive from the computer at least one of the purpose of a customer's visit and the customer's attribute information and thereby allows the visitor reception device 1 and the staff terminal 2 to share information such as information on the purpose of the customer's visit. This allows an employee to use the staff terminal 2 to designate, as a destination to which to guide the customer, a customer service area suitable for at least one of the purpose of the visit and the attribute information and to guide the customer to the destination to serve the customer there, thereby providing a visitor reception system that allows flexible guiding and service.

The visitor reception system may be further configured such that the staff terminal 2 includes: a display (that is, the touchscreen display 2A) configured to display at least one candidate for the destination among the plurality of customer service areas; and an input interface (that is, the touchscreen display 2A) configured to receive an operation for designating the destination from among the at least one candidate.

The above configuration allows an employee to see candidates on the display and operate the input interface to select from among the candidates a destination to which to guide the customer.

The visitor reception system may be further configured such that the plurality of customer service areas includes a first-level customer service area and a second-level customer service area, and the staff terminal is configured to designate the first-level customer service area or the second-level customer service area on a basis of the at least one of the purpose of the visit and the attribute information.

The above configuration allows an employee to select the first-level customer service area or the second-level customer service area in accordance with importance of the purpose of the visit and the attribute information.

In the above configuration, the basic customer service area E corresponds to a “first-level customer service area” and at least one of the individual customer service area F, the private customer service area G and the consultation room H corresponds to a “second-level customer service area”. Alternatively, the individual customer service area F may correspond to the “first-level customer service area”. In this case, the private customer service area G and the consultation room H correspond to a “second-level customer service area”. Alternatively, the individual customer service area F and the private customer service area G may correspond to the “first-level customer service area”. In this case, the consultation room H corresponds to the “second-level customer service area”.

The visitor reception system may be further configured such that the staff terminal operates to designate the second-level customer service area, which has a higher confidentiality level than the first-level customer service area, on a basis of the at least one of the purpose of the visit and the attribute information.

The above configuration allows an employee to select the first-level customer service area or the second-level customer service area in accordance with the confidentiality level of the purpose of the visit and the attribute information.

The visitor reception system may be further configured such that the visitor reception device includes a camera configured to capture an image of the customer's face, the staff terminal includes a display configured to display a vacant room as a candidate from among the first-level customer service area and the second-level customer service area together with the image of the customer's face.

The above configuration an employee to use the staff terminal 2 to designate, as a destination to which to guide the customer, a candidate for a customer service area suitable for at least one of the purpose of the visit and the attribute information from among the plurality of customer service areas, and allows flexible guiding and service including identity verification based on facial information.

The visitor reception system may be further configured such that the staff terminal is configured to designate the first-level customer service area or the second-level customer service area on a basis of a neural network identified through mechanical deep learning corresponding to an artificial intelligence.

The above configuration allows highly accurate guiding and service by the artificial intelligence.

The visitor reception system may be further configured such that the staff terminal 2 is configured to identify the at least one candidate on a basis of the at least one of the purpose of the visit and the attribute information.

The above configuration allows an employee to use the staff terminal 2 to designate, as a destination to which to guide the customer, a candidate for a customer service area suitable for at least one of the purpose of the visit and the attribute information from among the plurality of customer service areas.

The visitor reception system may be further configured such that the operation includes having reservation information read by the visitor reception device 1, the reservation information having been issued by an appointment system 7 of the financial facility, and the computer (that is, the graphic reader 1C or the management computer 6) is configured to determine the at least one of the purpose of the visit and the attribute information on a basis of the reservation information.

The above configuration allows the customer to have reservation information read by the visitor reception device 1 and thereby allows the computer to rapidly determine at least one of the purpose of the visit and the attribute information.

The visitor reception system may be further configured such that the operation includes having medium information read by the visitor reception device 1, the medium information being stored in a portable device owned by the customer, and the staff terminal 2 includes a display (that is, the touchscreen display 2A) configured to display determination information determined on a basis of the medium information.

The above configuration allows the customer to have medium information read by the visitor reception device 1 from a portable device owned by the customer and thereby allows an employee to use the staff terminal 2 to rapidly check determination information determined on the basis of the medium information.

The visitor reception system may be further configured such that the visitor reception device 1 includes a camera 1A configured to capture an image of the customer, and the staff terminal 2 includes a display (that is, the touchscreen display 2A) configured to display the image.

The above configuration allows flexible guiding and service including identity verification based on facial information.

### Alternative Embodiments

The present disclosure is not limited to the above embodiment as an example. The description below deals with embodiments of the present disclosure as other typical examples.

(1) The present disclosure is also applicable to a visitor reception method for a financial facility including a plurality of customer service areas (that is, the basic customer service areas E, the individual customer service areas F, the private customer service areas G, and the consultation room H), a visitor reception device 1 operable by a customer, and a staff terminal 2 operable by an employee, the visitor reception method including: determining at least one of a purpose of a visit of the customer and attribute information of the customer in response to the visitor reception device 1 receiving an operation from the customer; and designating from among the plurality of customer service areas a destination to which to guide the customer, the destination corresponding to the at least one of the purpose of the visit and the attribute information. With reference to FIG. 3, at least one of steps #05, #07, and #13 corresponds to the determining; and steps #14 to #16 correspond to the designating. The visitor reception method includes determining at least one of the purpose of the customer's visit and the customer's attribute information in response to the visitor reception device 1 receiving an operation from the customer. This allows an employee to designate, as a destination to which to guide the customer, a customer service area suitable for at least one of the purpose of the visit and the attribute information and to guide the customer to the destination to serve the customer there, thereby providing a visitor reception method that allows flexible guiding and service. The visitor reception method may be in the form of a computer program.

(2) The embodiment described above is configured such that the touchscreen display 2A doubles as a display and an input interface. The present disclosure is, however, not limited to such a configuration; the staff terminals 2 may each include a display configured or programmed to display at least one candidate for the destination among the plurality of customer service areas and a separate input interface (for example, a physical button) configured or programmed to receive an operation for designating the destination from among the at least one candidate.

(3) The visitor reception device 1 for the present disclosure does not necessarily involve a graphic reader 1C to read reservation information, and may alternatively be configured to read reservation information by means of, for example, connection to a smartphone 5 in conformity with Bluetooth or Wi-Fi Direct. The graphic reader 1C may be configured to obtain text information, in which case the graphic reader 1C may have an optical character recognition (OCR) function for obtaining text information and an AI-OCR function based on an artificial intelligence for determining whether the text information that the graphic reader 1C has obtained reflects any misrecognition.

(4) The embodiment described above is configured such that the staff terminals 2 are each configured or programmed to identify candidates for a customer service area on the basis of visitor reception information. The present disclosure is, however, not limited to such a configuration; the staff terminals 2 may alternatively be each configured to automatically designate a customer service area as a destination to which to guide a customer on the basis of visitor reception information. The visitor reception device 1 may, for instance, have an interactive AI chat function and be configured to analyze the customer's voice and/or the text input to obtain information on at least one of the purpose of the customer's visit and the customer's attribute information and allow a staff terminal 2 to automatically designate a customer service area as a destination to which to guide the customer on the basis of the above information.

(5) The staff terminals 2 may each be configured not to cause the touchscreen display 2A to display a customer's image that the camera 1A has captured.

(6) The embodiment described above is configured such that the graphic reader 1C reads a graphic code including information on the purpose of a customer's visit. The present disclosure is, however, not limited to such a configuration; the management computer 6 may be configured to store information on the purpose of a customer's visit, so that the graphic code includes no such information. In this case, the processor of each staff terminal 2 may be configured to request information on the purpose of a customer's visit from the management computer 6 on the basis of visitor reception information in step #12 in FIG. 3 and receive the information from the management computer 6 in step #13 in FIG. 3.

(7) The embodiment described above is configured such that the graphic reader 1C reads a graphic code including information on the purpose of a customer's visit. The present disclosure is, however, not limited to such a configuration; the graphic code may include a customer's attribute information (for example, their name, age, gender, family make-up, deposit, and recent transactions). The graphic code may include information on both the purpose of a customer's visit and the customer's attribute information or on a customer's attribute information alone. The graphic reader 1C may, in other words, be configured to function as a determiner for determining at least one of the purpose of a customer's visit and the customer's attribute information on the basis of what operation the customer has carried out on the visitor reception device 1 or on the basis of reservation information.

(8) As described above, the communication module of each staff terminal 2 receives information including visitor reception information from the visitor reception device 1 in step #11 in FIG. 3. The present disclosure is, however, not limited to such a configuration; the visitor reception device 1 may be configured to transmit information including visitor reception information to the management computer 6, so that the communication module of the staff terminal 2 receives the information from the management computer 6.

(9) The embodiment described above is configured such that the processor of a staff terminal 2 causes its touchscreen display 2A to display a customer's facial image from the visitor reception device 1 in step #15 in FIG. 3. The present disclosure is, however, not limited to such a configuration; the processor of each staff terminal 2 may be configured to cause the touchscreen display 2A to display a customer's attribute information (for example, their name, age, gender, family make-up, deposit, and/or recent transactions) in addition to or in place of the customer's facial image. The staff terminals 2 may be each configured to, if the touchscreen display 2A is not large enough to display all information, cause the touchscreen display 2A to, for instance, display a “See more” touch button for an employee to touch to cause the touchscreen display 2A to display, for example, a pop-up or scrollable screen related to the customer's attribute information.

(10) The embodiment described above is configured to selectively use two or more customer service areas (namely, the basic customer service areas E, the individual customer service areas F, the private customer service areas G, and the consultation room H) depending on the purpose or a customer's attributes. The present disclosure is, however, not limited to such a configuration; the embodiment may be altered to selectively use, for example, only two or more private customer service areas G and at least one consultation room H as customer service areas depending on a customer's attributes.

The configurations disclosed in the above embodiments (including the other embodiments, the same applies hereinafter) may be implemented by being combined with configurations disclosed in other embodiments as long as no contradiction arises. The embodiments disclosed in the present specification are examples, and embodiments of the present disclosure are not limited to the above embodiments. The disclosed embodiments can be modified as appropriate within a scope not departing from the object of the present disclosure.

The present disclosure is applicable to a visitor reception system and a visitor reception method.

What is claimed is:

1. A visitor reception system for a financial facility including a plurality of customer service areas,
the visitor reception system comprising:
a visitor reception device disposed at the financial facility and configured to receive an operation from a customer;
a computer configured to determine at least one of a purpose of a visit of the customer and attribute information of the customer in response to the operation; and
a staff terminal operable by an employee of the financial facility and configured to (i) obtain the at least one of the purpose of the visit and the attribute information that the computer has determined and (ii) designate from among the plurality of customer service areas a destination to which to guide the customer, the destination corresponding to the at least one of the purpose of the visit and the attribute information.

2. The visitor reception system according to claim 1, wherein
the staff terminal includes a display configured to display at least one candidate for the destination from among the plurality of customer service areas and configured to receive an operation for designating the destination from among the at least one candidate.

3. The visitor reception system according to claim 2, wherein the plurality of customer service areas includes a first-level customer service area and a second-level customer service area, and
the staff terminal is configured to designate the first-level customer service area or the second-level customer service area on a basis of the at least one of the purpose of the visit and the attribute information.

4. The visitor reception system according to claim 3, wherein
the staff terminal operates to designate the second-level customer service area, which has a higher confidentiality level than the first-level customer service area, on a basis of the at least one of the purpose of the visit and the attribute information.

5. The visitor reception system according to claim 3, wherein
the visitor reception device includes a camera configured to capture an image of the customer's face,
the staff terminal includes a display configured to display a vacant room as a candidate from among the first-level customer service area and the second-level customer service area together with the image of the customer's face.

6. The visitor reception system according to claim 4, wherein
the visitor reception device includes a camera configured to capture an image of the customer's face,
the staff terminal includes a display configured to display a vacant room as a candidate from among the first-level customer service area and the second-level customer service area together with the image of the customer's face.

7. The visitor reception system according to claim 3, wherein
the staff terminal is configured to designate the first-level customer service area or the second-level customer service area on a basis of a neural network identified through mechanical deep learning corresponding to an artificial intelligence.

8. The visitor reception system according to claim 2, wherein
the staff terminal is configured to identify the at least one candidate on a basis of the at least one of the purpose of the visit and the attribute information.

9. The visitor reception system according to claim 1, wherein
the operation includes having reservation information read by the visitor reception device, the reservation information having been issued by an appointment system of the financial facility, and
the computer is configured to determine the at least one of the purpose of the visit and the attribute information on a basis of the reservation information.

10. The visitor reception system according to claim 1, wherein
the operation includes having medium information read by the visitor reception device, the medium information being stored in a portable device which is owned by the customer, and
the staff terminal includes a display configured to display determination information determined on a basis of the medium information.

11. The visitor reception system according to claim 1, wherein
the visitor reception device includes a camera configured to capture an image of the customer, and
the staff terminal includes a display configured to display the image.

12. A visitor reception method for a financial facility including a plurality of customer service areas, a visitor reception device operable by a customer, and a staff terminal operable by an employee of the financial facility,
the method comprising:
determining at least one of a purpose of a visit of the customer and attribute information of the customer in response to the visitor reception device receiving an operation from the customer; and
designating from among the plurality of customer service areas a destination to which to guide the customer, the destination corresponding to the at least one of the purpose of the visit and the attribute information.
